(19) United States
(12) Patent Application Publication
(10) Pub. No.: US 2006/0226624 A1
(43) Pub. Date: Oct. 12, 2006

(54) Supporting device attachable to vehicle tire

(75) Inventor: Hsueh-Hsia Chen, Taichung Hsien (TW)

Correspondence Address: CHARLES E. BAXLEY, ESQ., 90 JOHN STREET, THIRD FLOOR, NEW YORK, NY, 10038, US

(73) Assignee: Kuei Pao CHEN

(21) Appl. No.: 11/215,158

(22) Filed: Aug. 30, 2005

(30) Foreign Application Priority Data
Apr. 12, 2005 (TW) 094205621

(51) Int. Cl. B60R 3/00

(52) U.S. Cl. 280/165

(57) ABSTRACT

A supporting device for attaching to a tire of a vehicle includes a support member, and an attaching device for attaching the support member to the tire of the vehicle. The attaching device includes a frame attached to the support member and having an opening for engaging onto the tire of the vehicle, and an anchoring device attached to a partition of the support member, for engaging with the tire and for anchoring and for securing the frame to the tire of the vehicle. The support member may be used for supporting one or more users, to allow the user to easily climb up or to reach the upper portion of the vehicle, or to attach various cargo onto the upper portion of the vehicle.

### BACKGROUND OF THE INVENTION

1. Field of the Invention

The present invention relates to a supporting device, and more particularly to a supporting device for selectively and detachably attaching to a tire of a vehicle, and for supporting one or more users thereon, and for allowing the user to easily climb up to or to reach the upper portion of the vehicle.

2. Description of the Prior Art

Typical large vehicles, such as wagons, sports vehicles, pickups, vans, trucks, etc., may comprise a great height, such that the users may not easily climb up or reach the upper portion of the vehicles.

For example, while traveling, one or more objects or cargo, such as luggage materials, boars, ski boards, bicycles, etc., may be required to be attached or disposed on top of the vehicles, and may further be required to be secured to the vehicles with such as fasteners, straps, anchor ropes, etc.

Normally, the users or the drivers have to prepare and carry a ladder with them, and to dispose the ladder within the vehicle, for using the ladder to climb up or to reach the upper portion of the vehicles. However, it is inconvenient to carry the ladder with the users.

Some of the vans may include a ladder attached to the rear portion thereof. However, it is also inconvenient for the users to go to the front and upper portion of the vehicle, when the upper portion of the vehicle has been occupied and stacked with various kinds of objects or luggage materials. Furthermore, the ladder is solidly attached and secured to the rear portion of the vans, and may not be disengaged from the vans, for supporting the users.

The present invention has arisen to mitigate and/or obviate the afore-described disadvantages of the conventional supporting devices.

### SUMMARY OF THE INVENTION

The primary objective of the present invention is to provide a supporting device for selectively and detachably attaching to a tire of a vehicle, and for supporting one or more users thereon, and for allowing the user to easily climb up or to reach the upper portion of the vehicle.

In accordance with one aspect of the invention, there is provided a supporting device comprising a support member, and an attaching device for attaching the support member to a tire of a vehicle.

The attaching device includes a frame attached to the support member, and having an opening formed therein, for engaging onto the tire of the vehicle. The support member is inclined relative to the frame. The support member includes an anti-slip surface provided thereon.

An anchoring device may further be provided for anchoring the frame to the tire of the vehicle. The support member includes a partition provided between the frame and the support member, and the anchoring device includes at least one anchoring device attached to the partition, for engaging with the tire, and for securing the frame to the tire of the vehicle.

The partition includes at least one protrusion extended therefrom and having a hole formed therein, the anchoring device includes a fastener extended therefrom, for threading with the hole of the protrusion, and for adjusting the anchoring device relative to the frame and the support member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a side plan schematic view of a vehicle having a supporting device in accordance with the present invention attached to a tire thereof;

FIG. 2 is a partial front plan schematic view of the vehicle having the supporting device attached to the tire thereof;

FIG. 3 is a top plan schematic view illustrating the attachment of the supporting device to the tire of the vehicle;

FIG. 4 is a perspective view of the supporting device for attaching to the tire of the vehicle;

FIG. 5 is a partial exploded view of the supporting device for the vehicle;

FIG. 6 is a top plan schematic view of the supporting device for attaching to the tire of the vehicle;

FIG. 7 is a perspective view illustrating the operation of the supporting device; and

FIG. 8 is a perspective view similar to FIG. 7, illustrating the other application of the supporting device.

### DETAILED DESCRIPTION OF THE PREFERRED EMBODIMENT

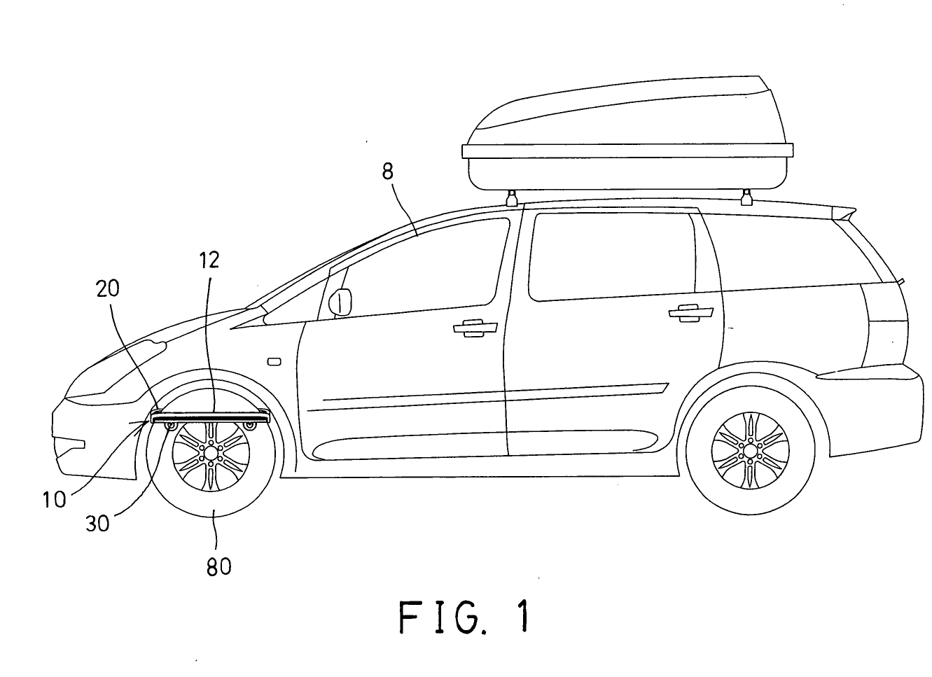

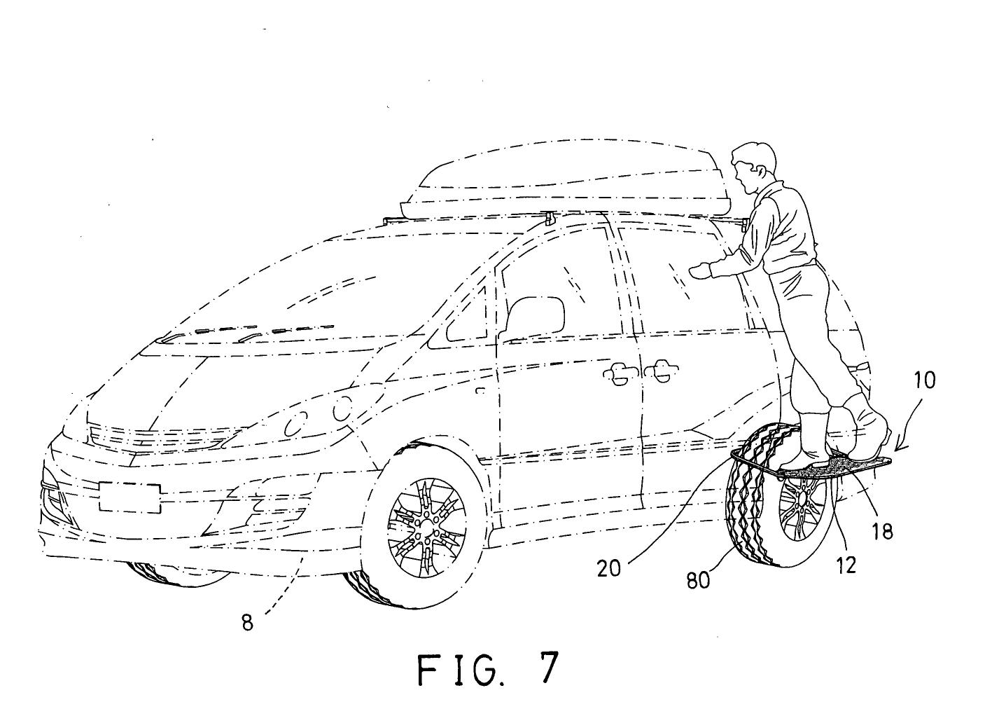

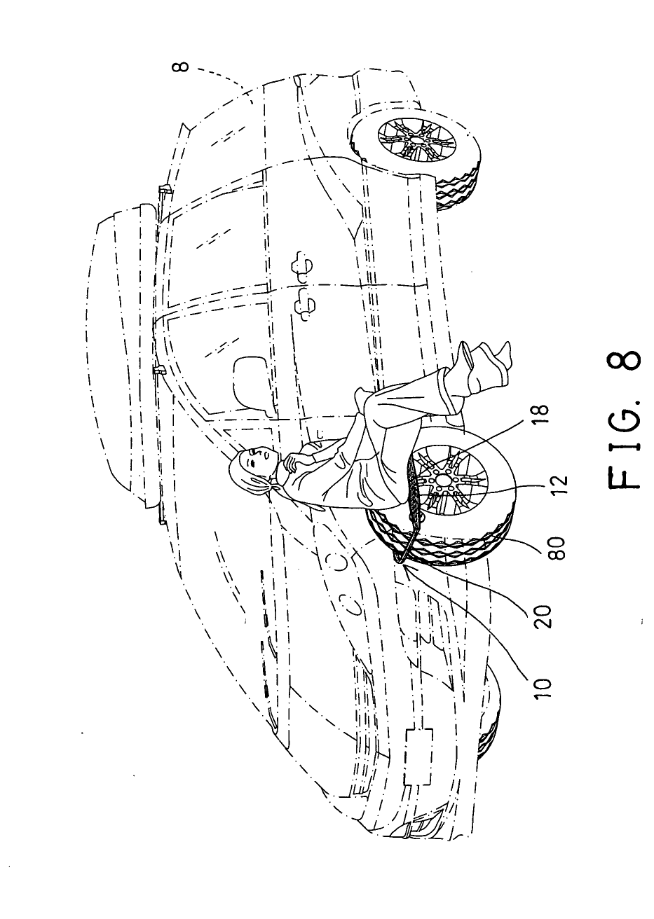

Referring to the drawings, and initially to FIGS. 1-3, a supporting device 10 in accordance with the present invention comprises a support member 12, such as a plate or table 12, for attaching to a tire 80 of a vehicle 8, such as a wagon, a sports vehicle, a pickup, a van, a truck, or the like, as shown in FIGS. 1-3, and 7-8, and for supporting one or more users thereon (FIGS. 7, 8), and for allowing the user to easily climb up or to reach the upper portion of the vehicle 8 (FIG. 7).

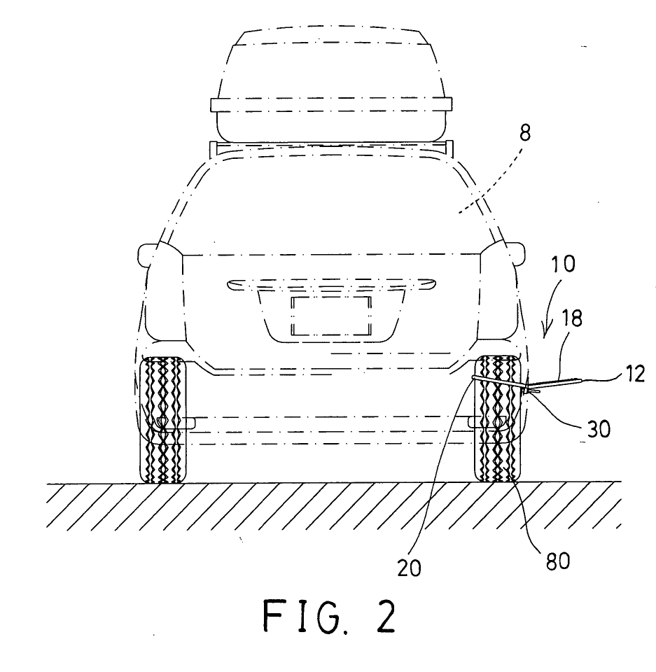

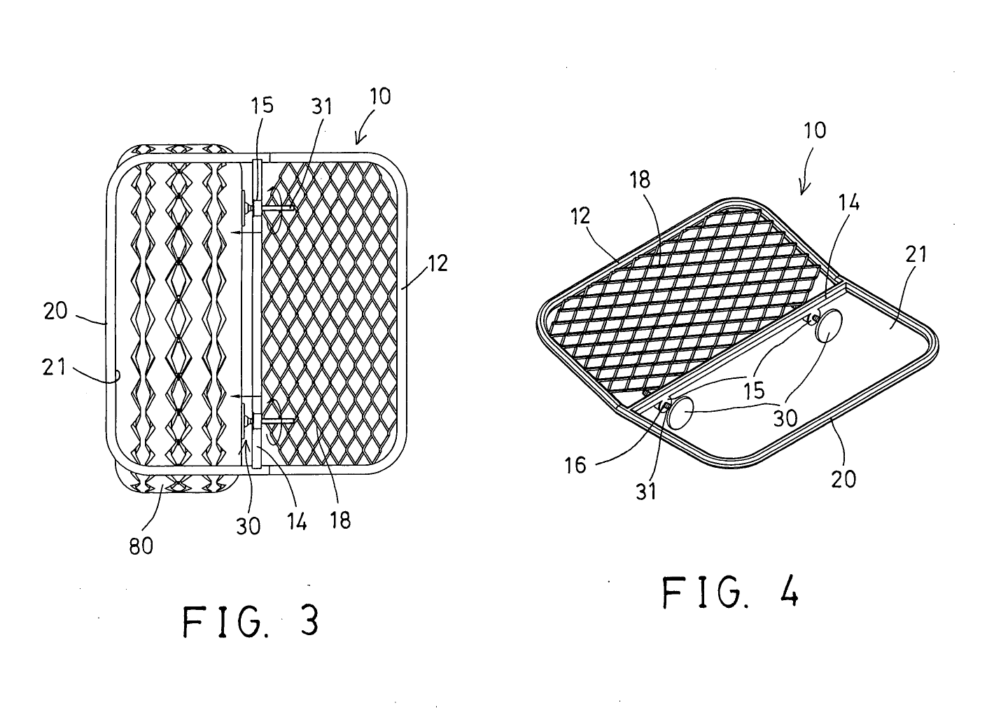

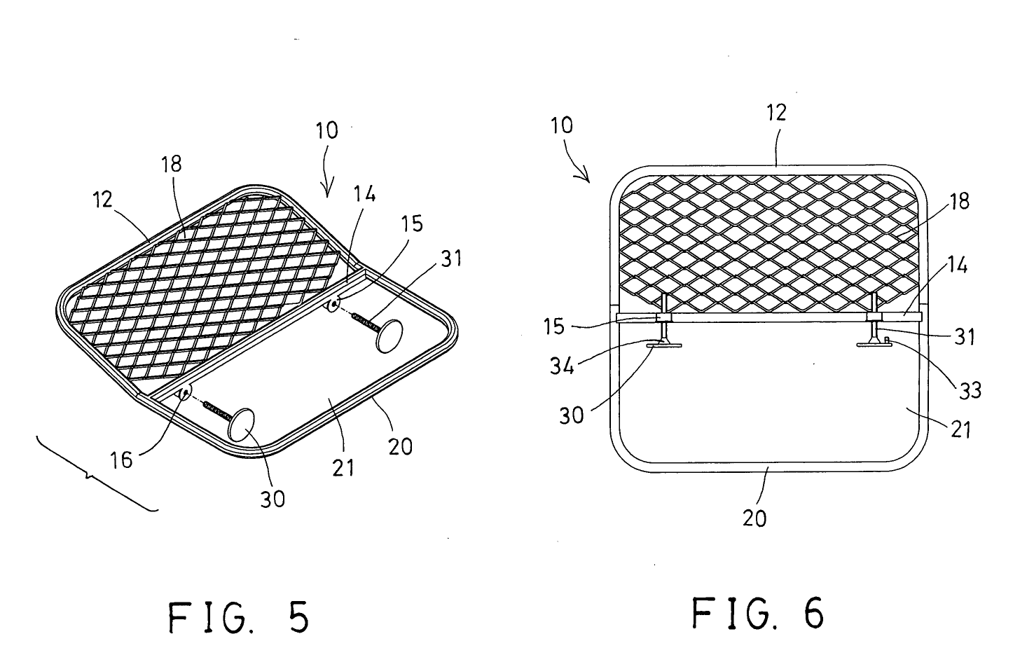

For example, as best shown in FIGS. 3-6, the supporting device 10 further includes a frame 20 attached to or secured to or formed integral with the support member 12, and having an opening 21 formed therein, for engaging onto or for attaching onto the tire 80 of the vehicle 8 (FIGS. 2-3, 7-8). It is preferable that the opening 21 of the frame 20 includes a length or longitudinal dimension smaller than the diameter of the tire 80, and includes a width or lateral dimension greater than the width of the tire 80, for allowing the frame 20 to be attached onto various kinds of tires 80.

The supporting device 10 includes a partition 14 attached to or disposed or provided between the support member 12 and the frame 20, and having one or more, such as two protrusions 15 extended therefrom, and having a hole 16, such as a screw hole 16 formed in each of the protrusions 15, for threading with a fastener 31 of an anchoring means or positioning member or device 30, and thus for allowing the anchoring device 30 to be moved or adjusted relative to the partition 14 and the support member 12 and the frame 20, and for engaging with the tire 80, and for securing the frame 20 of the supporting device 10 to the tire 80 of the vehicle 8 (FIGS. 2, 3).

It is preferable that the anchoring device 30 includes one or more wings or projections 33 extended therefrom (FIG. 6), for allowing the anchoring device 30 to be easily rotated or threaded relative to the protrusions 15 by the users. The anchoring device 30 may further include a non-circular segment 34 extended or provided thereon (FIG. 6), for engaging with various driving tools (not shown), and for allowing the anchoring device 30 to be easily rotated or threaded relative to the protrusions 15 by the driving tools.

As best shown in FIGS. 2 and 4, it is preferable that the support member 12 is slightly bent or inclined relative to the frame 20, for allowing the anchoring device 30 to be easily rotated or threaded relative to the protrusions 15 by the driving tools or by the users, or for allowing the support member 12 to be supported on a horizontal position or on a position slightly inclined upwardly relative to the horizontal plane or ground, for allowing the user to be stably supported on or above the support member 12.

It is preferable that the support member 12 includes an anti-slip or serrated surface or pad 18 formed or provided thereon, for further stably support the user on or above the support member 12. The frame 20 and the anchoring device 30 may thus be formed as an anchoring or attaching means or device for suitably attaching or securing the support member 12 to the tire 80 of the vehicle 8.

None of the conventional support members or tables or plates may be attached or secured to the tires of the vehicles, to suitably support the user thereon, and to allow the user to easily climb up or to reach the upper portion of the vehicle 8, and for allowing the users to easily attach or secure various cargo or objects onto the upper portion of the vehicles 8.

Accordingly, the supporting device in accordance with the present invention may be provided for selectively and detachably attaching to a tire of a vehicle, and for supporting one or more users thereon, and for allowing the user to easily climb up or to reach the upper portion of the vehicle.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A supporting device comprising:
a support member, and
means for attaching said support member to a tire of a vehicle.

2. The supporting device as claimed in claim 1, wherein said attaching means includes a frame attached to said support member, and having an opening formed therein, for engaging onto the tire of the vehicle.

3. The supporting device as claimed in claim 2 further comprising means for anchoring said frame to the tire of the vehicle.

4. The supporting device as claimed in claim 3, wherein said support member includes a partition provided between said frame and said support member, and said anchoring means includes at least one anchoring device attached to said partition, for engaging with the tire, and for securing said frame to the tire of the vehicle.

5. The supporting device as claimed in claim 4, wherein said partition includes at least one protrusion extended therefrom and having a hole formed therein, said at least one anchoring device includes a fastener extended therefrom, for threading with said hole of said at least one protrusion, and for adjusting said at least one anchoring device relative to said frame and said support member.

6. The supporting device as claimed in claim 2, wherein said support member is inclined relative to said frame.

7. The supporting device as claimed in claim 1, wherein said support member includes an anti-slip surface provided thereon.
